(19) United States
(12) Patent Application Publication
(10) Pub. No.: US 2002/0158918 A1
(43) Pub. Date: Oct. 31, 2002

(54) Method and apparatus for visualizing correlations among and between objects and events

(75) Inventors: Eliot Feibush, Pennington, NJ (US); Nikhil Gagvani, Princeton, NJ (US); Elena Greene, Princeton, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/108,270

(22) Filed: Mar. 27, 2002

Related U.S. Application Data
(60) Provisional application No. 60/333,112, filed on Mar. 28, 2001.

(51) Int. Cl. G09G 5/00

(52) U.S. Cl. 345/853

(57) ABSTRACT

A method and apparatus for visualizing correlations among and between objects and events stores objects, events, and correlations to form a query space. The query space includes a correlation graph having a node for each of the objects and events, and an edge for each of the correlations. Each of the edges in the correlation graph connects either two of the nodes, or one of the nodes and another one of the edges. In response to a query performed in the query space, the present invention visualizes at least a subset of the nodes and edges to form a result space.

### CROSS-REFERENCE TO RELATED APPLICATIONS

This application claims benefit of U.S. provisional patent application serial number 60/333,112, filed Mar. 28, 2001, which is herein incorporated by reference.

### BACKGROUND OF THE INVENTION

1. Field of the Invention

The present invention generally relates to data processing and, more particularly, to a method and apparatus for visualizing correlations between and among objects and events.

2. Description of the Related Art

Data provided from disparate sources can refer to objects and their attributes, as well as events associated with those objects. Objects and events can be related to each other in numerous ways, including by type and by context. Such relationships cannot be fully understood when the data is presented in a textual format. Although present databases can represent structured, tabular data, such databases cannot adequately represent textual information rich in semantics (i.e., relationships between various items in the textual information). Furthermore, many correlations in everyday life are uncertain or ambiguous and have a probability associated therewith that existing tools cannot easily model or represent.

Therefore, there exists a need in the art for a method and apparatus for visualizing correlations among and between objects and events.

### SUMMARY OF THE INVENTION

The disadvantages associated with the prior art are overcome by a method and apparatus for visualizing correlations among and between objects and events. In particular, the present invention stores data representing objects, events, and correlations to form a query space. The query space comprises a correlation graph having a node for each of the objects and events, and an edge for each of the correlations. Each of the edges in the correlation graph connects either two of the nodes, or one of the nodes and another one of the edges. In response to a query performed in the query space, the present invention visualizes at least a subset of the nodes and edges to form a result space. In one embodiment, the result space comprises icons, colors, and various other graphics that form a visual representation of the query results. Through the creation of a visual representation of subsets of data, a user can narrow in on doubtful probabilities or previous unknown possibilities. In this manner, the present invention advantageously visualizes correlations between and among objects and events that are difficult to determine when shown using pure textual representations.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a high-level block diagram of a general purpose computer suitable for implementing processes and methods according to the present invention;

FIG. 2 depicts a flow diagram showing an illustrative method of visualizing correlations among and between objects and events in accordance with the present invention;

FIG. 3 depicts a more detailed flow diagram showing a method of storing objects, events, and correlations in a correlation graph;

FIG. 4 illustrates an illustrative visualization of a correlation graph embodying the principles of the present invention; and

FIGS. 5 through 7 depict illustrative output visualizations of sub-graphs extracted from the correlation graph of FIG. 4.

### DETAILED DESCRIPTION

The present invention is a method, apparatus, and computer readable medium for visualizing correlations between and among objects and events. The present invention creates a visualization framework for visually representing objects, events, and correlations using perceptually appropriate visual metaphors. In particular, a query space comprises a correlation graph having a node for each object and event, and an edge for each correlation. The query space is multi-variate and multi-dimensional. Queries are performed in the query space, and the results are visualized in result space. In this manner, the present invention can be used to visualize correlations between and among objects and events, including non-adjacent objects and events, which would otherwise be difficult to determine when visualized using pure textual representations.

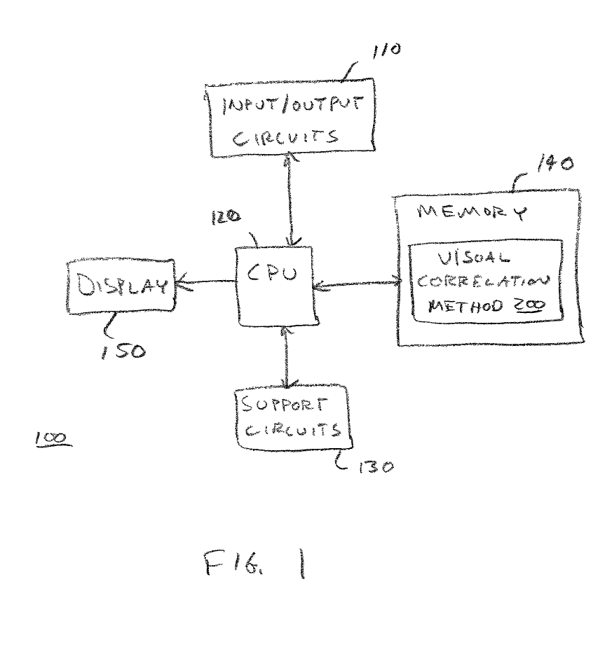

FIG. 1 depicts a high-level block diagram of a general purpose computer 100 suitable for implementing processes and methods according to the present invention. The general purpose computer 100 comprises a central processing unit (CPU) 120, a memory device 140, a variety of support circuits 130, an input/output (I/O) circuit 110, and a display 150. The CPU 120 can be any type of processor such as a PENTIUM 4 manufactured by Intel Corporation or a POWERPC manufactured by Motorola, Inc. The support circuitry 130 for the CPU 120 includes conventional cache, power supplies, clock circuits, data registers, I/O interfaces and the like. The I/O circuit 110 generally includes a conventional keyboard, mouse, printer and interface circuitry adapted to receive and transmit data, such as data files and the like. The memory device 140 can be random access memory (RAM), read only memory (ROM), hard disk storage, floppy disk storage, compact disk storage or any combination of these and similar storage devices. The display 150 is a monitor or like type display device known in the art.

The memory device 140 stores the program or programs (e.g., visual correlation method 200) that are executed to implement the methods of the present invention. When the general-purpose computer 100 executes such a program, it becomes a specific-purpose computer, that is, the computer becomes an integral portion of a system implementing the methods and processes of the present invention. Although the invention has been disclosed as being implemented as an executable software program, those skilled in the art will understand that the invention may be implemented in hardware, software, or a combination of hardware and software. Such implementations may include a number of processors independently executing various programs and dedicated hardware such as application specific integrated circuits (ASICs).

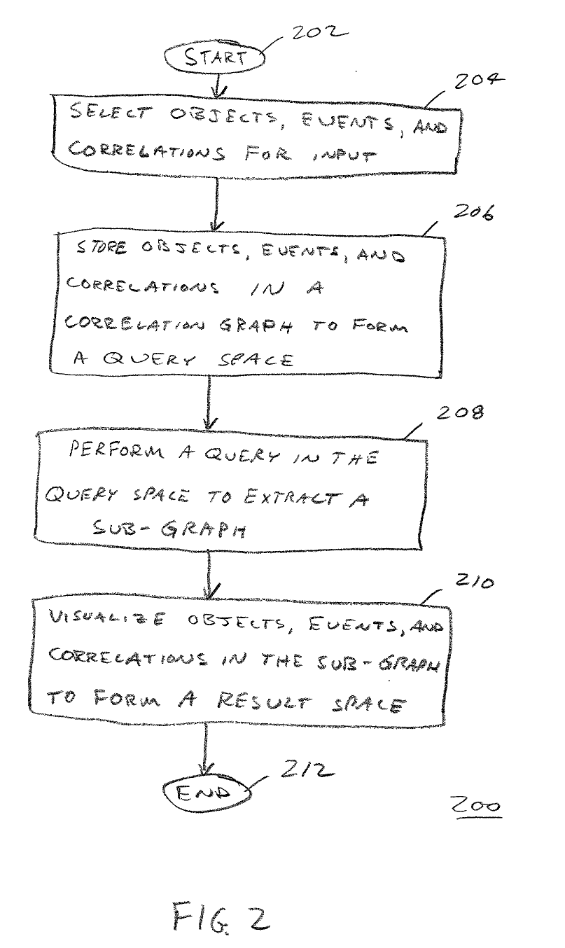

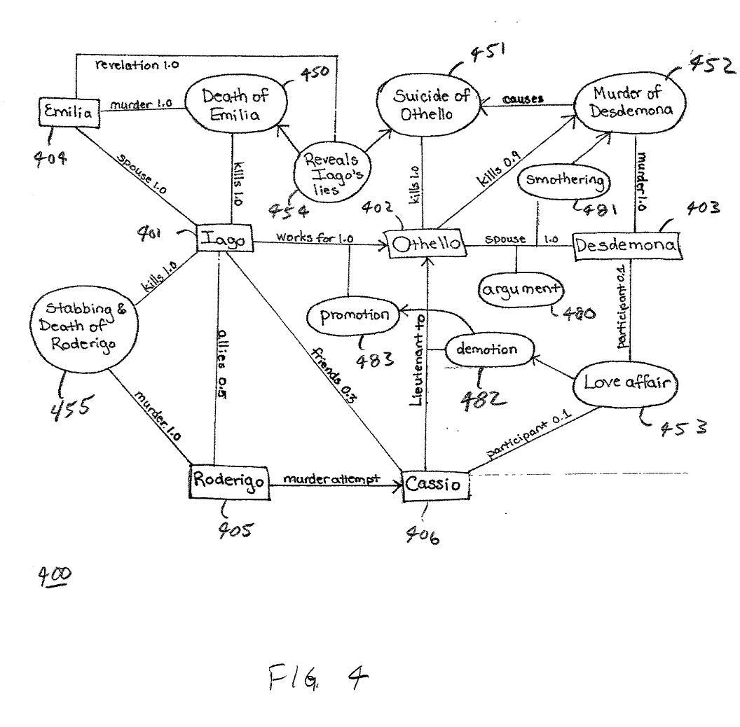

FIG. 2 depicts a flow diagram showing a method 200 of visualizing correlations among and between objects and events in accordance with the present invention. The method 200 starts at step 202. At step 204, data representing objects, events, and correlations are selected for input. At step 206, the input objects, events, and correlations are stored in a correlation graph to form a query space. As described in more detail below, the correlation graph comprises an abstract data structure that can quantify the degree of correlation between non-adjacent objects and events, and allows for complex queries to be performed in the query space. At step 208, a query is performed in the query space to extract a sub-graph. The sub-graph comprises at least a sub-set of the objects, events, and correlations conforming to the query (of course all the data stored can be displayed as described below with respect to FIG. 4). At step 210, the method 200 visualizes the objects, events, and correlations in the sub-graph to form a result space. The method 200 ends at step 212.

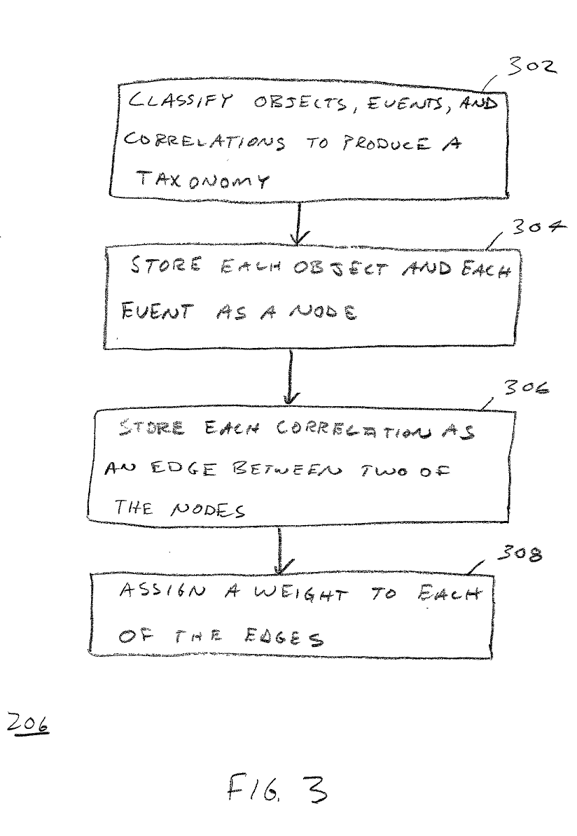

FIG. 3 depicts a more detailed flow diagram showing the storing step 206. Specifically, the data representing objects, events, and correlations are classified to produce a taxonomy at step 302. In one embodiment, each object is a tangible entity that occupies a physical location or region in space and has a state with multiple attributes associated therewith. Each object can stand alone without any link to other entities in the correlation graph. For example, an object may comprise an apple. An apple's location is contingent upon whether it is on the tree or on the table, its state includes attributes such as color, size, and taste, and a name, such as McIntosh. An apple exists on its own and can be represented without any connection to another object, event, or correlation.

Each event is a change in the state or attributes of an object or correlation at an instant in time or over a time interval. As such, each event in the correlation graph is connected to either an object or a correlation and has a specific time assigned to it. Time can be specified as a time instant (e.g., May 24^{th}, 10 a.m.) or a time interval. A time interval can be bounded (e.g., Jan 1, 2000 to Feb. 2, 2002) or half-bounded (prior to Dec. 7, 1965). A single event may only change one attribute of the object or correlation at a time. In the taxonomy of the present embodiment, there are two types of events: object-events and object-object correlation events. An object-event is an event associated with an object, and an object-object correlation event is an event associated with a correlation between two objects.

An example of an object-event is the falling of an apple (an object) from a tree to the ground. There is a change in the state of the apple in that the apple's location is transferred from the tree to the ground. There is a time instant in which this event (the falling of the apple) took place. The event changed a single attribute of the apple, namely, it's location. Other changes to the apple, such as eating the apple, would signify a separate event. An example of an object-object correlation event is the bruising of the apple when it falls. The objects modeled are the apple and the ground, and the correlation is contact between the apple and the ground. The event is the bruising of the apple, which results from the correlation between the apple and the ground.

Each correlation represents a relationship between different entities in the correlation graph. In the taxonomy of the present embodiment, there are four distinct types of correlations: an object-object event correlation (OOC), an object-event correlation (OEC), a correlation-event correlation (CEC), and an event-event correlation (EEC). An OOC is a correlation between two objects having a name signifying a distinct relationship, and a state that can possess multiple attributes. An OEC is a correlation between an object and an event having a name signifying the event that is taking place to the object. A CEC is a correlation between an event and another correlation that signifies a change in an object-object correlation, but not in the objects themselves. An EEC is a correlation between two events, and are directional signifying a cause-and-effect relationship.

At step 304, each object and each event is stored as a node in the correlation graph. At step 306, each correlation is stored as an edge between two entities in the correlation graph. The nodes and edges of the correlation graph are generally referred to herein as graph entities. At step 308, each edge is assigned a weight that is indicative of the relationship between two graph entities. For example, in one embodiment, each weight is a probability having a value between zero and one that is determined by the certainty of the correlation between graph entities (e.g., certainty of correlation between two objects, two events, an object and an event, or an event and another correlation).

Returning to FIG. 2, the result space comprises icons, colors, and various other graphics that form visual representations of the query results in step 208 on, for example, display 150. Graphical icons can be three-dimensional and can be depicted in a three-dimensional space. In addition, graphical icons can be animated and contain audio and/or video. Visualization step 210 effectively maps objects, events, and correlations in the query space to appropriate visual representations in result space. In this manner, the present invention provides perceptually appropriate visual metaphors that can facilitate interactive browsing of the data and provides better understanding and retention. Through the visual representation of data, such as textual reports, the correlation graph of the present invention simplifies and quantifies both vaguely abstract data and highly detailed or processed information. Those skilled in the art will appreciate that the visualization step 210 can also comprise building a physical model. For example, given query results from step 208, a user could assemble a model using plastic cubes and spheres to represent objects and events, respectfully, the plastic cubs and spheres being connected by plastic rods to represent the correlations.

FIG. 4 illustrates an exemplary visualization 400 in result space of a correlation graph embodying the principles of the present invention. In the present example, the correlation graph comprises data representing the Shakespearean tragedy Othello. The correlation graph of the present invention can be used to aid the understanding of a user unfamiliar with the story. The correlation graph neatly summarizes the major entities and events in the Shakespearean play in a single visual display. In the present example, the objects of the correlation graph are modeled as rectangles, the events are modeled as ellipses, and the correlations are modeled as links between entities. Of course the present visualization of the correlation graph is merely illustrative. Many other graphics, such as icons of various colors, can be used to represent the objects, events, and correlations that are within the spirit and scope of the present invention.

More specifically, the visualization 400 represents the six main characters lago, Othello, Desdemona, Emilia, Roderigo, and Cassio by rectangles 401, 402, 403, 404, 405, and 406, respectively. Each of the rectangles 401 through 406 represent the objects of the correlation graph. The visualization 400 represents the six main events “death of Emilia”, “suicide of Othello”, “murder of Desdemona”, “love affair”, “reveals lago's lies”, and “stabbing and death of Roderigo” by ellipses 450, 451, 452, 453, 454, and 455, respectively. Each of the ellipses 450 through 455 represent the object-events of the correlation graph. The visualization 400 also represents the four events “argument”, “smothering”, “demotion”, and “promotion” by ellipses 480, 481, 482, and 483, respectively. Each of the ellipses 480 through 483 represent the object-object correlation events of the correlation graph.

To briefly summarize the plot of the input data, Othello is the General of the Venetian forces and is married to Desdemona. The controversy starts as Roderigo, a citizen madly in love with Desdemona, is chastising lago, whom he has enlisted in tracking Desdemona's whereabouts. lago is Othello's ensign, and although Othello expects loyalty from his subordinates, lago is a jealous and conniving character who secretly harbors great hatred for Othello. lago assures Roderigo he is not allied with Othello and will aid him in getting Desdemona. Cassio is a Lieutenant to Othello and gets along well with Desdemona. lago, capitalizing on the friendship of the unsuspecting Cassio and Desdemona, manages to provoke the jealousy of both Roderigo and Othello. Othello becomes emotional and lago continues to amass signs of infidelity to further fan the flames of insecurity. lago gains favor with Othello as Cassio is removed from his position. Meanwhile, lago has persuaded Roderigo to kill Cassio and in a botched attempt, manages to kill Roderigo himself as Cassio escapes. As this scramble is occurring, Othello is busy smothering his wife to death. lago's wife, Emilia, enters to shed light on the lies that have led of to the events of this grave moment and is shortly thereafter stabbed by lago. Othello, overcome with inequitable agony and guilt, stabs himself.

As shown in FIG. 4, Othello (402) and Desdemona (403), two objects that are tangible beings and occupy specific regions in space, are husband and wife, respectively. The correlation between object 402 and object 403 is an OOC correlation and is represented by an edge titled “spouse” with a probability of 1.0 (i.e., determined with full certainty). In their married life, two events occurred that changed the relationship between the two, but did not change the two individuals themselves. These events are the object-object correlation event “argument” (480), and the object-object correlation event “smothering” (481). An argument might be a factor in the change of their “spouse” relationship, but it does not directly change the existence of the two objects 402 and 403. Also, the event “smothering” (481) is an event that occurred between Othello (402) and Desdemona (403) that changed the relationship between them, but not the objects themselves. The edges connecting the event “argument” (480) and the event “smothering” (481) to the edge connecting objects 402 and 403 are CEC correlations.

The event “murder of Desdemona” (452), however, is an event that occurs to Desdemona (403) and changes the state of Desdemona (403) from alive to dead. It is modeled as a separate event 452. There is a correlation of causation from the event “smothering” (481) to the event “murder of Desdemona” (452), which is indicated by an edge connecting the two events 481 and 452. This edge represents an EEC correlation, which is directional (i.e., the “smothering” event 481 causes the “murder of Desdemona” event 452). Another EEC correlation is found between the “suicide of Othello” event 451 and the “murder of Desdemona” event 452, since Desdemona's murder causes Othello's suicide (along with Emilia's revelation of lago's lies event 454). In addition, an edge connects the “Othello” object 402 with the “murder of Desdemona” event 452, which is titled “kills” having an assigned probability of 0.9. This edge is an OEC correlation. Likewise, various other correlations are dependent on the associated events of the objects involved, and can be understood with simultaneous reference to FIG. 4 and the synopsis described above. The probabilities shown in FIG. 4 that are less than 1.0 have been assigned for illustration purposes.

As described above with respect to FIG. 2, a query is performed in the query space to extract a sub-graph from the correlation graph. The sub-graph comprises at least a subset of the objects, events, and correlations. Although FIG. 4 illustrates an entire correlation graph for the input data, various subsets of the correlation graph can also be visualized to aid in the determination of correlations. For example, a cluster radial graph can be employed to arrange objects and events around a graph entity in a clockwise fashion. The proximity of the surrounding objects and events is determined by the probability assigned to the correlations between the entities. The resulting cluster is an axis of activity within the graph. Various clusters can be connected or compared in the result space for further scrutiny. In another example, a timeline correlation graph is employed to examine certain correlations between objects and events using a linear time model. The overlap of events, emergence of new correlations, and other similar assessments can result.

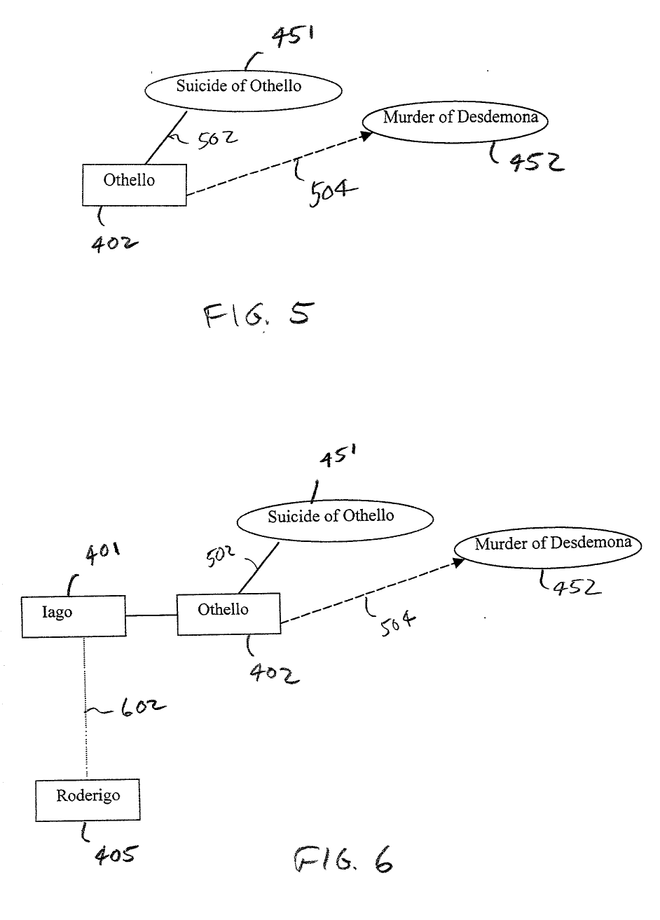

FIGS. 5 through 7 depict illustrative output visualizations of query-extracted sub-graphs. These visualizations can be depicted, for example, on display 150 or by a physical model. A user unfamiliar with the story of Othello could interactively perform queries in the query space to better understand the story. For example, a user could perform the following query: “Find Othello and all events directly connected to Othello.” The visualization of a sub-graph resulting from such a query is depicted in FIG. 5. As described above with respect to FIG. 4, the correlation between Othello (402) and “Suicide of Othello” (451) was assigned a probability of 1.0, and the correlation between Othello (402) and “Murder of Desdemona” (452) was assigned a probability of 0.9. As shown in FIG. 5, the higher probability correlation 502 is a solid line, whereas the lower probability correlation 504 is shown with a dashed line.

In another example, a user could perform the following query: “Find Roderigo and the shortest connection between the suicide of Othello and Roderigo.” The visualization of a sub-graph resulting from this query is depicted in FIG. 6. As described above with respect to FIG. 4, the most direct connection between Roderigo (405) and “Suicide of Othello” (451) is through the lago (401) and Othello (402) objects. The correlation 602 between lago (401) and Roderigo (405) is a dotted line indicating a lower probability (0.5 in the present example) than the correlation 504. The connection through Cassio (406) is not valid in the present example, since the correlation from Roderigo (405) and Cassio (406), as well as the correlation from Cassio (406) to Othello (402) is directional (indicated by arrows).

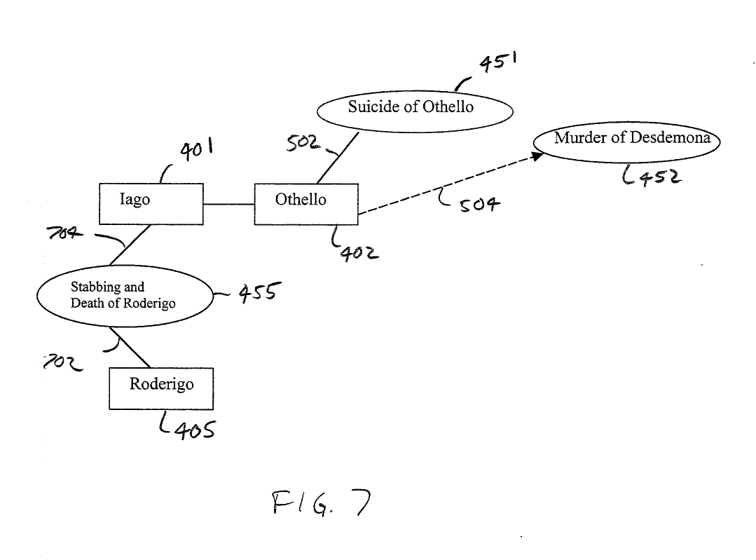

In yet another example, a user could perform the following query: “Find the most probable connection between the suicide of Othello and Roderigo.” The visualization of a sub-graph resulting from this query is depicted in FIG. 7. The present example illustrates that the most probable connection is not necessarily the most direct connection between objects and events. Two seemingly unrelated nodes (“Stabbing and death of Roderigo” event 455 and “Suicide of Othello” event 451) are shown to be the most probable connection. Again, correlation 702 between “Roderigo” (405) and “stabbing and death of Roderigo” (455) is depicted as a solid line, representing a high probability (in the present case 1.0). The correlation 704 between “stabbing and death of Roderigo” (455) and lago (401) is also a solid line. The use of rectangles, ellipses, and lines (solid, dotted, and dashed) is merely illustrative, as the result space can comprise icons, colors, and various other graphics that form visual representations on a computer display, as well as various three-dimensional shapes for building a physical model.

While the foregoing is directed to the preferred embodiment of the present invention, other and further embodiments of the invention may be devised without departing from the basic scope thereof, and the scope thereof is determined by the claims that follow.

1. A method of visualizing correlations among and between objects and events comprising:
storing objects, events, and correlations to form a query space, the query space having a node for each of the objects and events, and an edge for each of the correlations, each edge connecting either two of the nodes or one of the nodes and another of the edges; and
visualizing at least a subset of the nodes and edges to form a result space in response to a query performed in the query space.

2. The method of claim 1 further comprising:
classifying each event as one of an event associated with an object and an event associated with a correlation between two objects.

3. The method of claim 1 further comprising:
classifying each correlation as one of a correlation between an object and an event, a correlation between two objects, a correlation between two events, and a correlation between an event and a correlation.

4. The method of claim 1 wherein each edge is associated with a weight.

5. The method of claim 4 wherein each weight is a probability representing the certainty of the respective correlation.

6. The method of claim 1 wherein the step of visualizing comprises representing the nodes and edges using a plurality of graphical icons on a display.

7. The method of claim 1 wherein the step of visualizing comprises representing the nodes and edges using a physical model.

8. A computer readable medium having stored thereon instructions that, when executed by a processor, cause the processor to perform a method of visualizing correlations among and between objects and events comprising:
storing objects, events, and correlations to form a query space, the query space having a node for each of the objects and events, and an edge for each of the correlations, each edge connecting either two of the nodes or one of the nodes and another of the edges; and
visualizing at least a subset of the nodes and edges to form a result space in response to a query performed in the query space.

9. The computer readable medium of claim 8 further comprising:
classifying each event as one of an event associated with an object and an event associated with a correlation between two objects.

10. The computer readable medium of claim 8 further comprising:
classifying each correlation as one of a correlation between an object and an event, a correlation between objects, a correlation between events, and a correlation between an event and a correlation.

11. The computer readable medium of claim 8 wherein each edge is associated with a weight.

12. The computer readable medium of claim 11 wherein each weight is a probability representing the certainty of the respective correlation.

13. The computer readable medium of claim 8 wherein the step of visualizing comprises representing the nodes and edges using a plurality of graphical icons on a display.

14. An apparatus for visualizing correlations among and between objects and events comprising:
means for storing objects, events, and correlations to form a query space, the query space having a node for each of the objects and events, and an edge for each of the correlations, each edge connecting either two of the nodes or one of the nodes and another of the edges; and
means for visualizing at least a subset of the nodes and edges to form a result space in response to a query performed in the query space.

15. The apparatus of claim 14 further comprising:
means for classifying each event as one of an event associated with an object and an event associated with a correlation between two objects.

16. The apparatus of claim 14 further comprising:
means for classifying each correlation as one of a correlation between an object and an event, a correlation between objects, a correlation between events, and a correlation between an event and a correlation.

17. The apparatus of claim 14 wherein each edge is associated with a weight.

18. The apparatus of claim 17 wherein each weight is a probability representing the certainty of the respective correlation.

19. The apparatus of claim 14 wherein the means for visualizing comprises a display for representing the nodes and edges using a plurality of graphical icons.
